(19) United States
(12) Patent Application Publication
(10) Pub. No.: US 2005/0017395 A1
(43) Pub. Date: Jan. 27, 2005

(54) Method and device for producing a reinforced socket on an extruded thermoplastic tube by radial extrusion of a thermoplastic material

(76) Inventors: Karl Dietrich, Rain am Lech (DE); Peter Huebner, Augsburg (DE)

Correspondence Address: JORDAN AND HAMBURG LLP, 122 EAST 42ND STREET, SUITE 4000, NEW YORK, NY, 10168, US

(21) Appl. No.: 10/489,479

(22) PCT Filed: Oct. 23, 2002
(86) PCT No.: PCT/EP02/11848

(30) Foreign Application Priority Data
Oct. 25, 2001 (DE) 101 52 604.0

(51) Int. Cl. B29C 57/00

(52) U.S. Cl. 264/148; 425/392; 425/114; 264/159; 264/492

(57) ABSTRACT

The present invention relates to a method and an apparatus for producing a reinforced socket on an extruded plastic tube made of thermoplastic material, preferably a corrugated tube, in which the tube is provided with end sockets at predetermined segment lengths. One end of the plastic tube or of a segment thereof is placed on a support mandrel and together with this support mandrel is rotated about its longitudinal axis. During the rotation, a layer of plastic is extruded onto a pre-formed socket region of the tube and/or onto the support mandrel, forming a reinforced socket formed on the tube.

The invention relates to a method and an apparatus for producing a reinforced socket on an extruded plastic tube made of thermoplastic material, preferably a corrugated tube, in which the tube is provided with end sockets at predetermined segment lengths.

Plastic tubes in single-wall and multiple-wall embodiments, for instance double-wall corrugated tubes with a corrugated exterior wall and smooth interior wall, are produced from thermoplastic material by extrusion. The plastic tube extruded and shaped as a continuous strand is then separated from the continuously produced tube at predetermined segment lengths such that the result is tube segments of the desired length. At least one end of these tube segments must be provided with a socket with an expanded diameter or alternatively with a socket with the same exterior diameter with a smaller tip end of the tube in order to be able to connect the tube segments when they are placed. In order to produce such sockets, the sockets are formed in a manner known per se on the continuously extruded tube strand, whereby the sockets are exposed in that the tube strand is separated in the region of the shaped socket for producing the tube segments. In conventional extrusion processes, however, it is only possible to produce the sockets with a wall thickness that is approximately in the range of the wall thickness of the single- or multiple-wall tube. However, these wall thicknesses are frequently not adequate for producing sockets with the necessary strength.

The object of the invention is therefore to suggest a method and an apparatus of the type cited in the foregoing, whereby tube segments separated from extruded plastic tubes can be produced with reinforced sockets with greater wall thicknesses.

In accordance with the invention, this object is achieved using a method in accordance with patent claim 1 and an apparatus in accordance with patent claim 14.

In accordance with the invention, reinforced sockets can be produced in that at least one reinforcing layer of plastic is extruded onto the socket region, whereby the thermoplastic material extruded thereupon is the same as that of the plastic tube or is of a type that bonds well to the material of the plastic tube.

Usefully, the inventive method is embodied in that each tube segment is borne rotatable about its longitudinal axis and is displaced in rotation and a layer of plastic is extruded onto the socket region through a die head of an extruder. The at least one layer of plastic is so-to-say wound onto the socket region.

The layer of plastic can fundamentally be extruded by a flat sheet die, the extrusion slot of which can correspond to the length of the socket, while one or more rotations are extruded onto the tube segment. However, the layer of plastic reinforcing the socket is preferably applied through a profile extrusion die in the form of a strand, the width or thickness of which is a fraction of the socket length, in that the die head and/or the rotating tube segment is caused to move in the longitudinal direction of the tube segment in such a manner that the strand encompasses the socket region with turns, one on top of the other, in a helical shape. Profile extrusion dies with various cross-sections can be used for this. Circular cross-sections and rectangular cross-sections have proven to be advantageous. Profile extrusion dies with rhomboidal cross-sections can also be used.

The layer of plastic or turns can be applied in one layer or a plurality of layers.

In order to produce particularly strong sockets, in a further development of the invention a reinforcement such as glass fibers, polyamide wire, or metal wire can be included in the turns under and/or in the reinforcement profile. This can achieve reinforcement of the edge stress of the socket.

In order to provide a good bond between the extruded reinforcing layer and the socket region of the tube segment, the socket region can be heated prior to extruding the strand or the wide band thereupon. The heating can occur by blowing hot air, preferably by infrared radiation in front of the extrusion die. Preferably the tube segment is irradiated with one or a plurality of quartz radiators in the region of the socket to be formed in order to heat or soften the tube segment in the cited region.

Usefully the layer extruded thereupon is calibrated and smoothed by a profile roller.

Usefully a support mandrel provided with a rotating drive is introduced at least into the end of the tube segment that is provided with the socket. The support mandrel is usefully provided with a temperature control apparatus in order to be able to control the temperature of the support mandrel. In particular the support mandrel, through which a heating and/or cooling medium flows in bores via a rotating distributor, is heated or cooled by means of a temperature control device. The temperature of the support mandrel is thus controlled. In particular it can be heated prior to and during extrusion of the layer of plastic that forms the socket. The temperature can be selected depending on various edge conditions. A typical temperature range is approximately 150° C. After extrusion, the support mandrel is cooled in order to draw off the heat from the extruded plastic material and/or the tube material located thereunder.

In addition, a vacuum can be introduced via the rotating distributor in order to hold the heated socket with thickening to the support mandrel. The support mandrel can have vacuum slots on its exterior surface. In order to facilitate removal, the support mandrel can be embodied slightly conical overall. In addition, the vacuum system can be triggered with pressure in order to facilitate removal.

Usefully, the extruded socket can be cooled not solely from the interior, that is, by the support mandrel. A cooling device, in particular a cool air fan, can be provided at the exterior side of the tube in the region of the shaped socket in order to cool the extruded material.

Furthermore, there is a need to shape sockets and in particular reinforced sockets on tube segments made of extruded plastic tubes that have been extruded without a socket region. The invention also relates to a method for producing a reinforced socket on an extruded plastic tube made of thermoplastic material, preferably a corrugated tube, from which tube segments of a predetermined length are separated. In order to shape sockets on such tube segments that have been extruded without socket regions, each tube segment, at least at its end at which a socket is to be shaped, is placed on a rotatingly drivable mandrel, the exterior contour of which complements the interior socket region, and then the socket is extruded onto the mandrel adjacent to the tube segment. This extrusion occurs in that the extruded socket bonds to the end segment of the re-plasticized tube segment.

In accordance with this embodiment of the invention, the socket is extruded onto the mandrel in the same manner as was described in the foregoing in the extrusion method for producing at least one layer reinforcing the socket region.

The rotating drive for generating the rotational movement between the profile extrusion die of the extruder and the tube segment or the support mandrel can be embodied differently. It can be provided that the support mandrel, and thus the tube segment placed upon it, is driven directly. It can also be provided that the support mandrel is borne freely rotatable and the rotating drive at another site rotationally drives the tube segment and via it the support mandrel.

Exemplary embodiments of the invention are described in greater detail in the following, using the drawings.

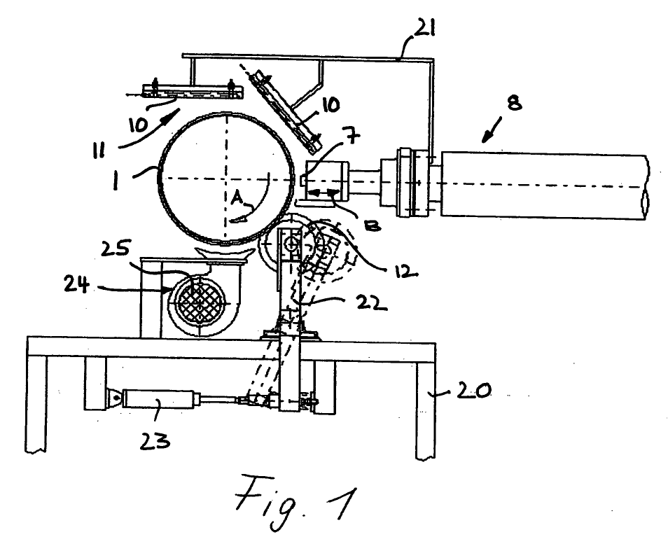

FIG. 1 is a schematic front elevation of an apparatus for producing or shaping a reinforced socket on a tube segment of an extruded plastic tube;

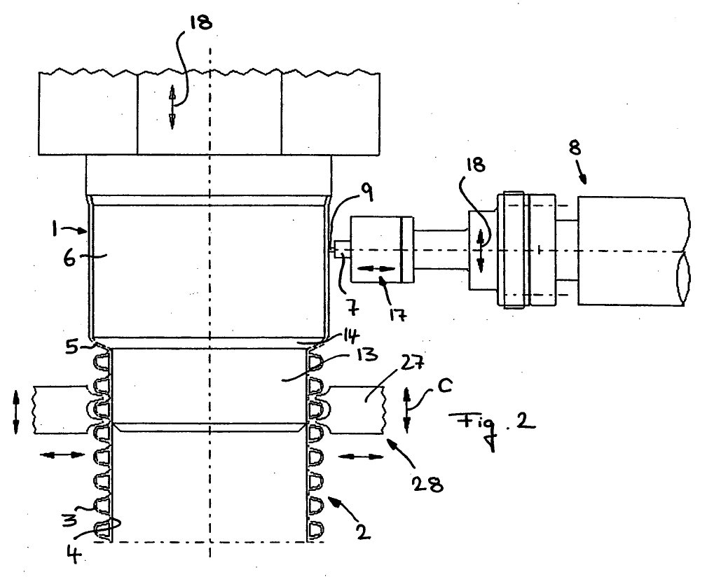

FIG. 2 is a top view of the apparatus in accordance with FIG. 1;

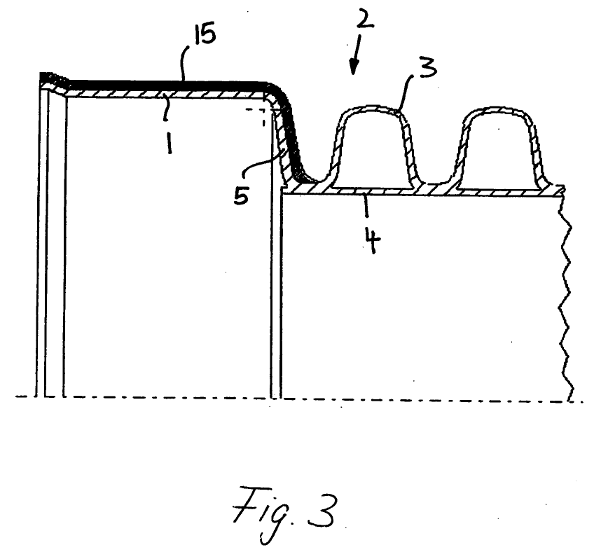

FIG. 3 is a section through the socket region of a double-wall tube that has been reinforced by a layer of plastic extruded thereupon;

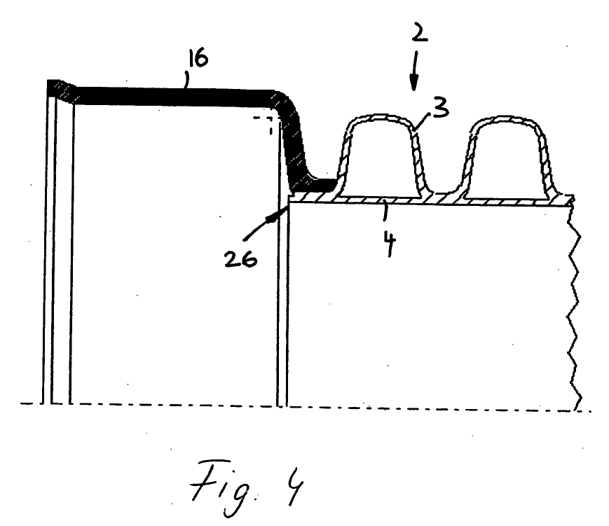

FIG. 4 is a section through the end of a double-wall corrugated tube onto which a reinforced socket has been extruded completely in a turning method;

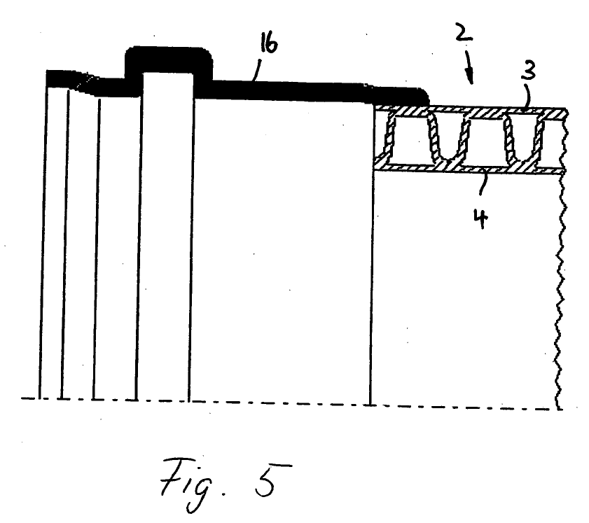

FIG. 5 is a section through the end of a triple-wall corrugated tube onto the exterior face of which a reinforced socket has been extruded completely in the turning method;

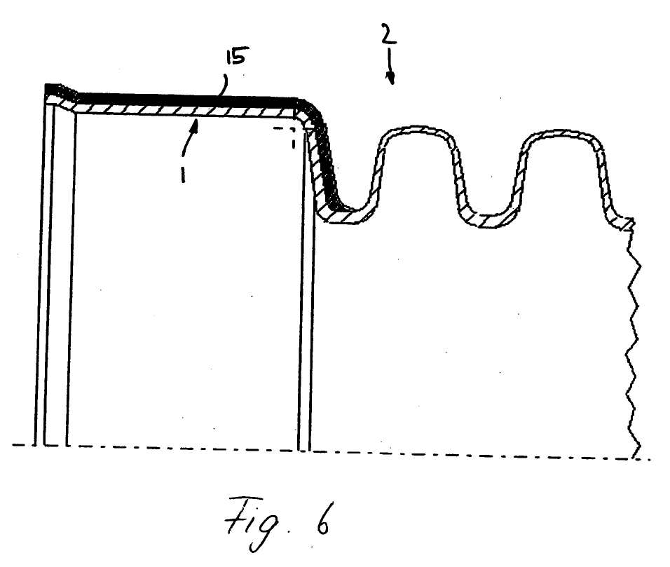

FIG. 6 is a section through the socket region of a single-wall corrugated tube that has been reinforced in accordance with an additional embodiment of the invention by a layer of plastic extruded thereupon; and,

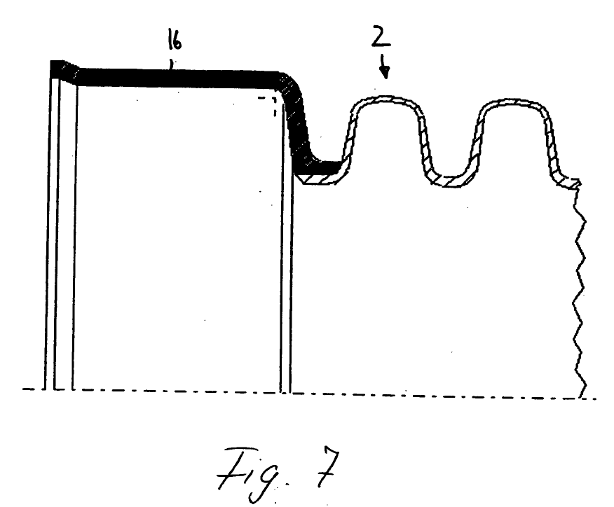

FIG. 7 is a section through the end of a single-wall tube, onto the face of which a reinforced socket has been completely extruded in the turning method.

FIG. 1 illustrates a front elevation of the socket region 1 of a tube segment 2 of an extruded plastic tube that is rotatably clamped in an apparatus (not shown in greater detail). The tube segment 2 has been extruded in a known manner as a double-wall tube with a corrugated exterior wall 3 and a smooth interior wall 4. The tube segment 2 has socket region 1, which is shaped during extrusion and has an expanded diameter and is joined to the welded tube walls by an annular or conical segment 5.

The tube segment 2 is rotatively clamped or borne in the bearing frame 20, whereby inserted at least into the socket region of the tube segment 2 is a rotatably borne holding or support mandrel 6, the exterior contour of which corresponds to the interior contour of the socket region 1, the transition region 5, and the diameter of the interior tube 4.

A tube clamping apparatus 28 can be provided in order to be able to receive the axial forces acting on the tube when the support mandrel is inserted and withdrawn. As FIG. 2 illustrates, the tube can be clamped using two or more preferably shell-shaped or segment-shaped clamping jaws 27. The clamping jaws can be moved radially toward and away from the tube. In addition, they are movable in the axial direction in accordance with the arrow C. They can be arranged on a slide that is movably borne corresponding to the bearing frame 20. The clamping jaws can have appropriately shaped receiving surfaces for double-wall tubes with corrugated exterior walls (see FIG. 2).

At the socket region 6 and the transition region 5, a profile extrusion die 7 can be placed, to which an extruder 8 feeds a plastic melt that is then extruded onto the socket region 1 and the transition region 5 in the form of a strand 9 of plasticized plastic during at least one rotation A. The profile extrusion die 7 can be moved back and forth in the direction of the double arrow B in order to be able to extrude the layer of plastic onto the socket region at the optimum distance.

Arranged immediately in front of the profile extrusion die 7 are the quartz radiators 10 of a heating device 11 that is movable with the profile extrusion die 7 and that plasticizes or slightly fuses the socket region that is to be provided with an extruded reinforcing layer. The contactless-acting heating device 11 could also fundamentally have hot air nozzles or the like in order to heat the tube segment. But infrared radiation is preferred. Preferably the heating device 11 is affixed to the profile extrusion head 7 or the extruder 8 so that movements by the profile extrusion die 7 are associated with a corresponding movement of the heating device 11 and the tube wall segment in front of the extrusion die is always heated. In accordance with FIG. 1, the quartz radiators 10 are affixed to a heating device carrier 21 that itself is affixed to the extruder or its extrusion head.

Arranged behind the profile extrusion die 7 is a profile roller 12 with which the extruded layer is calibrated and smoothed. As FIG. 1 illustrates, the profile roller 12 is borne on the bearing frame 20 and can be placed radial to the tube segment or support mandrel 6 via an adjusting drive. In the illustrated embodiment, the profile roller 12 is seated on a pivoted lever 22, borne on the bearing frame 20 about an axis that is parallel to the longitudinal direction of the tube, that is pivotable by means of a pressure means cylinder supported on the bearing frame 20.

Furthermore, a cooling device 24 for cooling the extruded plastic radially from the exterior is provided on the bearing frame 20. A cool air fan 25 blows cooling air onto the exterior surface of the reinforced socket region in an advantageous manner immediately behind the profile roller 12.

FIG. 3 illustrates a section through the socket region of a double-wall plastic tube with a corrugated exterior wall and a smooth interior wall, whereby a reinforcing layer of plastic 15 has been extruded onto the socket region 1 and the transition region 5 in the manner described in the foregoing.

The inventive method can also be embodied in such a manner that only the exterior segment 13 of the holding mandrel 6 corresponding to the diameter of the interior tube 4 is inserted into the tube segment produced without a socket region and then the socket is extruded onto the mandrel 6 with transition segment 14 and thus bonded to the tube segment 2.

FIG. 4 illustrates a section through the end of a double-wall plastic tube with a corrugated exterior wall and a smooth interior wall. The tube ends in a region in which the exterior wall is fused to the interior wall. Extruded onto this end segment 26 is the socket 16, which initially expands conically outward and thus connects to a cylindrical segment. The wall thickness of the socket 16 is substantially greater than that of the exterior wall and interior wall of the plastic tube.

FIG. 5 illustrates another possible socket shape. The three-wall plastic tube has a smooth exterior wall and a smooth interior wall, which are joined to one another by a corrugated wall. Extruded onto the exterior side of the exterior wall is the socket 16, which extends from the face beyond the end of the tube that was initially extruded without a socket. In the manner described in the foregoing the socket is extruded completely directly onto the mandrel projecting out of the tube using the turning method. In this case, as well, the socket 16 can be produced with a wall thickness that is substantially greater than that of the exterior wall or the interior wall of the tube.

FIGS. 6 and 7 illustrate reinforced sockets at the ends of a single-wall corrugated tube. In accordance with FIG. 6, a reinforcing layer of plastic can be extruded onto the shaped socket of the single-wall corrugated tube. In accordance with FIG. 7, a socket 16 can also be extruded onto the end of the tube initially produced without a socket.

1-22. (Canceled)

23. Method for producing a plurality of discrete plastic tubes of predetermined length, comprising extruding thermoplastic to form a continuous tube having sockets formed at intervals spaced lengthwise along the continuous tube, dividing the continuous tube into a plurality of discrete tubes each having, at an end thereof, a respective one of said sockets, and extruding onto a peripheral portion of each discrete tube, including the socket thereof, a reinforcing layer of thermoplastic.

24. Method according to claim 23, wherein each discrete tube is supported for rotation about a longitudinal axis of the discrete tube, said discrete tube is rotated about said axis, and the reinforcing layer of thermoplastic is extruded onto said peripheral portion of said discrete tube from an extruder having a die head positioned adjacent said peripheral portion.

25. Method according to claim 24, wherein the extrusion die is profiled so as to form a strand of the reinforcing thermoplastic which strand is of lateral dimension substantially less than axial length of the socket, and the method further comprises moving the extrusion die and/or the discrete tube in a direction of said longitudinal axis of the discrete tube while extruding the strand onto said peripheral portion thereby to form said reinforcing layer from the strand.

26. Method according to claim 24, wherein the extrusion die is profiled so as to form a sheet of the reinforcing thermoplastic of width at least about equal to axial length of the socket.

27. Method according to claim 25 wherein the strand is extruded onto said peripheral portion in superposed layers to form the reinforcing layer in a predetermined thickness.

28. Method according to claim 26, wherein the sheet is extruded onto said peripheral portion in superposed layers to form the reinforcing layer in a predetermined thickness.

29. Method according to claim 24, further comprising heating the peripheral portion beginning before the extruding of thermoplastic onto the peripheral portion so that the peripheral portion is in a heated state during the extruding of thermoplastic onto the peripheral portion.

30. Method according to claim 29, wherein the tube is rotated about the longitudinal axis thereof in a predetermined direction, and the heating comprises applying heating to the peripheral portion during said rotation at a position rotationally spaced from the extrusion head in a direction counter the direction of said rotation.

31. Method according to claim 30, wherein the heating comprises radiant heating.

32. Method according to claim 31, wherein the radiant heating is effected by a quartz radiant heater.

33. Method according to claim 30, wherein the heating is effected by blowing hot air.

34. Method according to claim 24, further comprising calibrating thickness of and/or smoothing the reinforcing layer by applying to said peripheral portion a roller having an axis of rotation parallel to the longitudinal axis of the discrete tube and having a profile complementary to a desired profile of the reinforcing layer.

35. Method according to claim 24, further comprising inserting a rotatable support mandrel into the discrete tube at the socket end thereof, the mandrel being inserted into the discrete tube by a length measured along said axis corresponding to at least the length of the socket measured along said axis.

36. Method according to claim 35, further comprising controlling temperature of the mandrel.

37. Method according to claim 36, wherein the controlling of the temperature of the mandrel comprises heating the mandrel prior to the extrusion of the reinforcing layer, maintaining temperature of the mandrel at a predetermined level during the extrusion of the reinforcing layer, and subsequently cooling the mandrel.

38. Method according to claim 23, wherein the continuous tube formed by extruding thermoplastic comprises corrugations.

39. Method for forming a socket on an end of a plastic tube of discrete axial length, comprising partially inserting a support mandrel into an end of the tube so that a portion of the mandrel protrudes from said end, said portion of the support mandrel having a profile corresponding to a desired profile of the socket, rotating the support mandrel together with the tube about a longitudinal axis of the tube, and extruding at least one layer of thermoplastic onto said portion of the rotating mandrel, the at least one layer forming the socket, the socket being bonded to the tube.

40. Method according to claim 39, wherein the extrusion of the thermoplastic is from an extruder having a die head positioned adjacent said portion of the mandrel.

41. Method according to claim 40, wherein the extrusion die is profiled so as to form a strand of the thermoplastic which strand is of lateral dimension substantially less than axial length of said portion, and the method further comprises moving the extrusion die and/or the mandrel together with the tube in a direction of said longitudinal axis of the tube while extruding the strand onto said portion of the mandrel thereby to form said socket from the strand.

42. Method according to claim 40, wherein the extrusion die is profiled so as to form a sheet of the thermoplastic of width at least about equal to axial length of said portion of the mandrel.

43. Method according to claim 41, wherein the strand is extruded onto said portion of the mandrel in superposed layers to form the socket in a predetermined thickness.

44. Method according to claim 42, wherein the sheet is extruded onto said portion of the mandrel in superposed layers to form the reinforcing layer in a predetermined thickness.

45. Method according to claim 40, further comprising calibrating thickness of and/or smoothing the socket by applying to said peripheral portion a roller having an axis of rotation parallel to the longitudinal axis of the discrete tube and having a profile complementary to the desired profile of the socket.

46. Method according to claim 39, wherein the tube comprises corrugations.

47. Apparatus for reinforcing a socket on an end of a plastic tube of predetermined length, comprising supports for supporting the tube, an extruder comprising an extrusion die positioned to be adjacent an end of a tube supported by the supports, a drive for providing relative rotation of the tube on the supports and the extrusion die about a longitudinal axis of the tube.

48. Apparatus according to claim 47, further comprising supports for the die head and a drive for moving the die head relative to the tube.

49. Apparatus according to claim 48, further comprising a mandrel for insertion in the tube at said end.

50. Apparatus according to claim 48, wherein the supports and drive for moving the die head effect relative helical movement of the die head about the axis of the tube.

51. Apparatus according to claim 49, further comprising means for heating and cooling the mandrel.

52. Apparatus according to claim 51, wherein the drive for providing relative rotation of the tube and the extrusion die rotates the tube and the heating means is positioned before the die head in the direction of said rotation.

53. Apparatus according to claim 51, further comprising a roller for calibrating and smoothing thermoplastic extruded through the die head onto the mandrel, the roller being positioned after the die head in the direction of said rotation.

54. Apparatus according to claim 53, wherein the cooling means comprises a blower for blowing ambient air onto the mandrel, the blower being positioned after the roller in the direction of rotation of the tube.

55. Apparatus according to claim 54, further comprising a clamp for clamping and axially fixing the tube when the mandrel is inserted into or removed from the tube.
